(19) United States
(12) Patent Application Publication
(10) Pub. No.: US 2023/0143439 A1
(43) Pub. Date: May 11, 2023

(54) A STETCHABLE STRAIN-SENSING POLYMER FIBER, DEVICES MADE THEREWITH, METHOD OF MAKING STETCHABLE STRAIN-SENSING POLYMER FIBER

(71) Applicant: VIRGINIA TECH INTELLECTUAL PROPERTIES, INC., Blacksburg, VA (US)

(72) Inventors: Yujing ZHANG, Blacksburg, VA (US); Xiaoting JIA, Blacksburg, VA (US)

(21) Appl. No.: 17/996,146

(22) PCT Filed: Apr. 27, 2021
(86) PCT No.: PCT/US2021/029285

§ 371 Date: Oct. 13, 2022

Related U.S. Application Data
(60) Provisional application No. 63/016,005, filed on Apr. 27, 2020.

(51) Int. Cl. G01L 1/24; G01L 1/22

(52) U.S. Cl. CPC G01L 1/242; G01L 1/22

(57) ABSTRACT

A stretchable polymer fiber can be used to form stretchable polymer fiber-based strain sensors. The stretchable polymer fiber-based strain sensors have a much larger strain range than existing stretchable polymer fiber-based strain sensors, good biocompatibility, and similar Young’s modulus as the human body. Woven into fabrics, the strain sensors can map the strain distribution at different locations and in different directions. The stretchable polymer fiber-based strain sensors can be implemented as resistance-based strain sensors, optical waveguide-based strain sensors, and as a combination of optical waveguide-based and resistance-based strain sensors.

### CROSS-REFERENCE TO RELATED APPLICATIONS

This application is a PCT international application that claims priority to, and the benefit of the filing date of, U.S. provisional application number 63/016,005, filed on Apr. 27, 2020, which is incorporated herein by reference in its entirety.

### TECHNICAL FIELD

The present disclosure relates to a stretchable strain-sensing fiber, devices made with the fiber and methods of making and using the stretchable strain-sensing fiber.

### BACKGROUND

Strain sensors are devices that can convert physical deformation into measurable signals. Conventional strain sensors are based on metals or semiconductors. They can provide good sensitivity, but can only sense small deformations (e.g., less than 5% strain), and thus are not suitable for human health monitoring. Human skin, body, and internal organs constantly undergo large strain and bending, and twisting deformations organized in a complex three-dimensional fashion. Therefore, deformation sensors play an indispensable role in modern wearable electronics, artificial skin, soft robotics, and biomedical devices. These known deformation sensors are typically based on stretchable planar devices or fiber devices. The planar devices are incompatible with the textiles weaving process and cannot be integrated onto complex nonplanar substrates. On the other hand, fiber-based devices can be woven into textiles or integrated onto arbitrary three-dimensional objects, making them ideal candidates for monitoring the complex activities of the human body in next-generation electronics. Also, because of the longitudinal nature of the fiber, it is also suitable for large scale longitudinal sensing, such as rope sensing.

To develop fiber-based deformation sensors, researchers have explored both electrical and optical detection strategies. Electrical detection methods, typically based on resistance, capacitance or inductance, utilize conductive materials, such as carbon nanomaterial, silver nanomaterial, and liquid metal, to serve as the sensing component. Among those methods, resistance-based sensors are most widely used due to their high sensitivity in strain deformation sensing and simple read-out electronics. However, those sensors alone are not capable of detecting the bending deformation. The optical fiber detection method, on the other hand, provides such a capability. Traditional optical fibers, including silica fiber and rigid polymer fiber, can only afford a small amount of strain (e.g. < 1% for silica fibers and < 12% for PMMA fibers). Recently, stretchable waveguides using elastomers or hydrogels have been designed and fabricated to meet the mechanical demands. Unfortunately, optical sensing alone cannot distinguish multimodal deformations, such as bending and stretching.

Coating and molding are the most commonly used methods for fabricating both electrical and optical fiber sensors. However, they generally are not compatible with large scale manufacturing. Extrusion and spinning techniques are promising alternatives to make scalable and stretchable fibers for industrial usage, but they are not able to produce fibers with complex architectures for simultaneous electrical and optical detection. Recently, the thermal drawing technique, which is conventionally used in the telecommunication industry, has been rapidly evolving as a powerful tool to fabricate multimaterial and multifunctional fibers. In the past decade, researchers have used this technique to fabricate novel fiber-based electrical and optical devices, including piezoelectric fibers, pressure sensing fibers, photonic bandgap fibers, and optoelectronic fibers. The thermal drawing technique is also highly scalable as hundreds of meters of fibers can be produced by one continuous drawing. Most recently, stretchable fiber devices made via the thermal drawing process have been reported and demonstrated as both stretchable fibers with a helix polycarbonate (PC) core and stretchable fibers with a liquid metal core for deformation sensing. However, the fiber with a helix PC core has a limited stretchability (~18%), and the fiber with a liquid metal core is not suitable for biomedical application because of the risk of metal leakage.

A stretchable and biocompatible nanowire-coated fiber has been produced using the thermal drawing technique and post-drawing dip-coating process for optoelectronic probing of spinal cord circuits. The post-dip-coating method can be used to prepare high conductivity meshes of silver nanowires (AgNWs) for stretchable electrodes, but it is not suitable for producing complex fiber architectures and is difficult to adapt to large scale manufacturing. Furthermore, the large propagation attenuation of the AgNWs coated stretchable waveguide (~3.98 dB/cm) may limit its application in deformation sensing that requires a relatively long fiber length.

Serpentine patterned electrodes, made from metal wire, soft conductive rubber and nanomaterials, have been developed to improve the stretchability of film-based devices for variable applications, such as sensors, energy sources and integrated electronics. However, limited by the current fabrication strategies, it is still challenging to develop similar three-dimensional (3-D) spiral patterns - especially for highly stretchable low modulus electrodes - to extend the mechanical deformation range of fiber-based devices.

A need exists for a stretchable strain-sensing fiber that overcomes the aforementioned disadvantages.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A is a schematic diagram of a thermal drawing process used to manufacture the strain sensing fibers from a preform in a way that gives the fibers a core-sheath structure in accordance with a representative embodiment.

FIG. 1B is an optical microscopic image of a cross-section of one of the fibers after etching (scale bar: 100 µm) showing the core and the sheath; the bottom image in FIG. 1B is a scanning electron microscope (SEM) image of the carbon black particles (CBs) in the core of the fiber, which exhibits a uniform distribution of CBs after the thermal drawing process.

FIG. 1C is a side-view image of the core-sheath structure of the fiber under 0% strain.

FIG. 1D is a side-view image of the core-sheath structure of the fiber under 750% strain showing that the electrode breaks into pieces when the fiber is under such strain (scale bar: 300 µm).

FIG. 1E is a schematic diagram of a thermal drawing process used to manufacture the strain sensing fiber from a preform that is rotated during the drawing process to give the fiber the aforementioned helix structure.

FIG. 1F shows optical images of double-helix fibers obtained by using different rotation rates of the preform 1 during drawing (scale bar: 3 mm).

FIGS. 1G and 1F show side views of the helix structure of the fiber shown in FIG. 1E under the strain of 0% and 750%, respectively.

FIG. 1H is an enlarged view of a portion of the fiber shown in FIG. 1G.

FIGS. 2A - 2D schematically illustrate the fabrication process for fabricating the stretchable electrodes in accordance with a representative embodiment; FIG. 2A shows the process by which the CB particles are first embedded into a SEBS1 (Kraton, G1657) sheet by compression in a hot press.

FIG. 2B is a top view of the compressed sheet with the embedded CB particles, which is diced and then the die are delivered to an extruder.

FIG. 2C depicts the process of the die shown in FIG. 2B being received in the extruder, which extrudes a cylindrical preform in which the electrode is embedded.

FIG. 2D depicts three of the cylindrical preforms made by the process of FIGS. 2A - 2C.

FIG. 3A depicts the process of preparing the cylindrical preform in accordance with a representative embodiment in which the preform having the stretchable electrode in the center is wrapped in an insulating layer an is then wrapped in a sacrificial PMMA film that helps to hold the fiber shape during thermal drawing and that gets etched away after drawing.

Figs. 4Aand 4B are plots of the Temperature vs. Viscosity characteristics of SEBS1 before and after loading it with 11 wt% CB, respectively.

FIG. 4C is a plot of Temperature vs. Viscosity characteristics of SEBS2.

FIGS. 5A - 4D depict side-view SEM images showing surface morphology of, respectively, an electrical fiber sensor having a core-sheath structure, an electrical fiber sensor having a helix structure, stretchable optical fiber, and multifunctional fiber with optical waveguide and electrodes.

FIG. 6 is a plot of the rotation rate during the drawing process vs. the helix pitch that shows the relationship between the pitch and the rotation speed when the drawing speed was fixed at 85 cm·min⁻¹.

FIG. 7A shows stress-strain curves for preform materials G1657, G1652 and G1657 + CB.

FIG. 7B shows stress-strain curves for an electrical fiber sensor with a core-sheath structure, an electrical fiber sensor with a helix structure, a stretchable optical fiber and a multifunctional fiber with optical waveguide and electrodes.

FIG. 7C shows stress-strain curves of the fiber strain sensors for applied strains of 20%, 40%, 60%, 80% and 100%, showing the mechanical hysteresis of the sensor according to the various applied strains.

FIGS. 8A - 8F are curves showing different electrical characterization of the fiber sensors in accordance with a representative embodiment; FIG. 8A is a plot of resistance change ΔR/R₀ = (R -R₀)/R₀, where R is the measured resistance, and R₀ is the original resistance before stretching) as a function of the tensile strain (quasi-static loading). as a function of the applied strain; FIG. 8B is a plot of the hysteresis performance of the fiber sensor; FIG. 8C is a plot of the normalized resistance changes of the strain sensor against repeated strains of 100, 150, and 200%; FIG. 8D is a plot of stability of the resistance response of the fiber strain sensor to the repeated strains of 40% over 1000 cycles; FIG. 8E is a plot of the relative resistance change of the fiber sensor as a function of curvature; FIG. 8F is a plot of stability of the resistance response of the fiber strain sensor to the repeated bending curvature of 100 m⁻¹ over 1000 cycles.

FIG. 9 is a plot of resistance change ΔR/R₀ = (R -R₀)/R₀ as a function of the applied strain for the five cycles.

FIG. 10 shows an optical image of an end face of a stretchable optical waveguide in accordance with a representative embodiment as well as the same fiber guiding light in it original stretched and bent states.

FIGS. 11A and 11B demonstrate the optical transmission and loss, respectively, as a function of wavelength and length, respectively, for the stretchable optical waveguide shown in FIG. 10.

FIGS. 12A and 12B show the normalized optical transmission as a function of curvature and percentage strain, respectively.

FIG. 13A is a photograph of such a stretchable optical waveguide having two electrodes in accordance with a representative embodiment, and also shows a photo of an end view of the stretchable fiber optical waveguide having first and second electrodes.

FIG. 13B shows the performance of the stretchable O/E fiber shown in FIG. 13A in terms of optical transmission loss as a function of bending and in terms of relative resistance as a function of stretching.

FIGS. 14A and 14B show smart gloves that were manufactured by handweaving electrical fiber sensors into commercial gloves in accordance with a representative embodiment.

FIGS. 15A and 15B show a wrist brace that was to incorporate the fibers in accordance wi9th a representative embodiment.

FIGS. 16A - 16D show the strain-sensing performance of a mesh having six of the resistance-based fibers of the type shown in FIG. 1A woven into it in a 3x3 pattern.

FIG. 17A is a photograph of a pig bladder having a fiber mesh mounted thereon comprising four transverse and two longitudinal resistance-based fibers of the type shown in FIGS. 1A - 1D for sensing expansion and shrinkage of the bladder in different directions as liquid is injected into and extracted from the bladder.

FIG. 17B shows the resistance change of a transverse fiber at the middle of the bladder (fiber T1 in FIG. 17A) and a representative longitudinal fiber (fiber L1 in FIG. 17A) when 400mL water was injected and subsequently removed from the bladder.

FIG. 18 shows the resistance response of fibers T2, T3, T4 and L2 shown in FIG. 17A when 400 mL water is injected and subsequently removed from the bladder manually.

FIG. 19 shows live-dead test results using mouse embryonic fibroblasts (NIH/3T3) after 3 and 5 days showing no significant difference in cell visibility between the control and cultures with fibers present on Day 3 (p=0.4046) and Day 5 (p=0.5457), which suggests that the fiber is highly biocompatible and does not impact cell viability.

FIG. 20 is a block diagram of a strain sensor system 150 in accordance with a representative embodiment that processes the signals that are output from any of the strain sensors shown FIG. 1A - 18 to determine the strain exerted on the strain sensor.

### DETAILED DESCRIPTION

A stretchable polymer fiber is disclosed herein that can be used to form a stretchable polymer fiber-based strain sensor. The stretchable polymer fiber-based strain sensors disclosed herein have a much larger strain range than existing stretchable polymer fiber-based strain sensors, good biocompatibility, and similar Young’s modulus as the human body. Woven into fabrics, the strain sensors disclosed herein can map the strain distribution at different locations and in different directions. The stretchable polymer fiber-based strain sensors can be implemented as resistance-based strain sensors, optical waveguide-based strain sensors, and as a combination of optical waveguide-based and resistance-based strain sensors.

In accordance with inventive principles and concepts disclosed herein, methods are provided for designing and fabricating highly stretchable, scalable, and biocompatible electrical and optical fiber sensors that are capable of multimodal extreme deformation sensing. The aforementioned thermal drawing process preferably is used to fabricate the fibers. The fibers can have, for example, a core-sheath structure exhibit high stretchability (>580%), large sensing range (up to ~400%), high sensitivity (gauge factor (GF) up to 1960), and high durability during 1000 stretching and bending cycles. In some embodiments the fibers can have a helix design that allows the fibers to withstand even higher strain (>750%). In some embodiments, stretchable step-index optical fibers are produced that are sensitive to bending and stretching. In addition, in some embodiments, multifunctional fibers are fabricated that combine both electrical and optical detection functionality and can be used for quantifying and distinguishing different kinds of deformations, such as bending and stretching, for example.

In the following detailed description, a few illustrative, or representative, embodiments are described to demonstrate the inventive principles and concepts. For purposes of explanation and not limitation, representative embodiments disclosing specific details are set forth in order to provide a thorough understanding of an embodiment according to the present disclosure. However, it will be apparent to one having ordinary skill in the art having the benefit of the present disclosure that other embodiments that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

The terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements’ relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a non-transitory computer-readable storage medium that is capable of storing computer instructions, or computer code, for execution by one or more processors. References herein to “memory” or “memory device” should be interpreted as one or more memories or memory devices. The memory may, for example, be multiple memories within the same computer system. The memory may also be multiple memories distributed amongst multiple computer systems or computing devices.

A “processor”, as that term is used herein encompasses an electronic component that is able to execute a computer program or executable computer instructions. References herein to a computer comprising “a processor” should be interpreted as one or more processors or processing cores. The processor may for instance be a multi-core processor. A processor may also refer to a collection of processors within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers.

Exemplary, or representative, embodiments will now be described with reference to the figures, in which like reference numerals represent like components, elements or features. It should be noted that features, elements or components in the figures are not intended to be drawn to scale, emphasis being placed instead on demonstrating inventive principles and concepts.

To demonstrate the potential application of the fibers as wearable devices, a glove integrated with fiber sensors is presented herein that can track finger movements to control a virtual hand model, a wrist brace for monitoring wrist flexion and extension, and a fiber mesh capable of two-dimensional strain mapping. It is also demonstrated herein that the fiber mesh with good biocompatibility could be used to monitor expansion and shrinkage of a porcine bladder, indicating the potential of the fiber sensors to be implemented as biomedical implantable devices.

### 1. Sensing Principles

In accordance with a representative embodiment, strain sensing is achieved using stretchable polymer fiber. Physical deformation of the fiber is converted into electrical and/or optical signals that are measured to determine the amount of strain exerted on the fiber. In accordance with a representative embodiment, a stretchable polymer, such as a polyethylene (PE), polyvinylidene fluoride (PVDF), polycarbonate (PC), poly(methyl methacrylate) (PMMA), and stretchable thermal plastic elastomer (TPE), for example, is doped with electrically-conductive (EC) particles, such as carbon black (CB) particles (CBs), for example. When doped with the EC particles, the stretchable TPE can function as a stretchable electrode. When the doped polymer fiber is stretched, some conductive paths formed by the EC particles inside of the polymer fiber disconnect, which increases the electrical resistance of the polymer. Similarly, when the stretching force exerted on the polymer fiber is released, the conductive paths formed by EC particles reconnect, which decreases the resistance of the polymer. If an electrical current is passed through the doped polymer fiber, the change in the resistance can be determined based on a measured change in electrical current or voltage. The amount of strain exerted on the fiber can then be determined based on the change in resistance, or it can be determined directly from the measured change in voltage or current.

In accordance with another representative embodiment, rather than doping the stretchable polymer fiber with EC particles, the polymer fiber has at least one hollow channel formed therein that is filled with an EC liquid, such as liquid metal, for example. When the fiber is stretched, the length of the liquid increases and the cross-sectional area of the liquid decreases. This causes the electrical resistance of the liquid to increase, and the change in the resistance can be determined based on a measured change in electrical current or voltage. The amount of strain can then be determined based on the change in resistance, or it can be determined based directly on the change in voltage or current. Also, if the fiber has multiple hollow channels formed in it that are filled with the EC liquid to form respective electrodes, the electrical capacitance between the electrodes will also change when the fiber is stretched or released. The change in capacitance can then be used to determine the amount of strain on the fiber.

Stretchable fibers in accordance with the above described representative embodiments are referred to herein as resistance-based fiber electrodes because the strain is typically determined based on the change in resistance, although strain can be determined directly from the change in voltage, current, or in some cases, based on the change in capacitance.

In accordance with another representative embodiment, multiple polymers are used to form a stretchable optical waveguide that can be used as an optical strain sensor. For example, two transparent TPEs with different refractive indices can be used to form a stretchable optical waveguide. A TPE with a higher refractive index can comprise the core of the fiber and a TPE with a lower refractive index can comprise the cladding surrounding the core. When the fiber is stretched or bent and released, the optical loss of light carried along the fiber will change. The amount of strain can then be determined based on a measurement of the change in optical transmission or loss.

In accordance with another representative embodiment, the stretchable optical waveguide includes one or more electrodes. When the waveguide is stretched or bent and released, the optical loss of light carried along the fiber will change, as will the electrical resistance of the electrode(s). The amount of strain and bending curvature can then be determined based on the change in optical transmission or loss and/or based on the change in resistance.

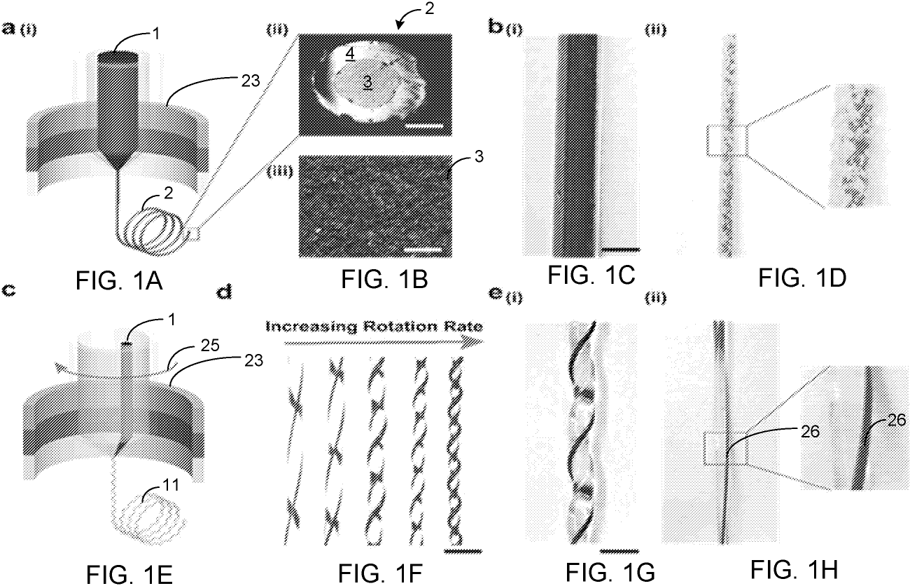

FIGS. 1A - 1H depict fabrication of electrical strain sensing fibers in accordance with a representative embodiment. FIG. 1A is a schematic diagram of a thermal drawing process used to manufacture the strain sensing fibers 2 from a preform 1 in a way that gives the fibers a core-sheath structure in accordance with a representative embodiment. The top image in FIG. 1B is an optical microscopic image of a cross-section of one of the fibers after etching (scale bar: 100 µm) showing the core 3 and the sheath 4. The bottom image in FIG. 1B is a scanning electron microscope (SEM) image of the CBs in the core 3 of the fiber, which exhibits a uniform distribution of CBs after the thermal drawing process. The size of the CBs is typically between 50 and 100 nm, although the inventive principles and concepts are not limited with respect to the size or distribution of the CBs. FIG. 1C is a side-view image of the core-sheath structure of the fiber under 0% strain. FIG. 1D is a side-view image of the core-sheath structure of the fiber under 750% strain showing that the electrode breaks into pieces when the fiber is under such strain (scale bar: 300 µm). FIG. 1E is a schematic diagram of a thermal drawing process used to manufacture the strain sensing fiber 11 from a preform 1 that is rotated during the drawing process to give the fiber the aforementioned helix structure. FIG. 1F shows optical images of double-helix fibers 11 obtained by using different rotation rates of the preform 1 during drawing (scale bar: 3 mm). Arrow 25 in FIG. 1F depicts rotation of the preform 1 by a controllable rotation mechanism (not shown) during the drawing process. FIGS. 1G and 1F show side views of the helix structure of the fiber 11 under the strain of 0% and 750%, respectively. As seen in FIG. 1H, the electrode 26 of the fiber 11 remains continuous when the fiber is under 750% strain (scale bar: 500 µm).

### 2. Results and Discussion

### 2.1 Fabrication of Electrical Fiber for Strain Sensing

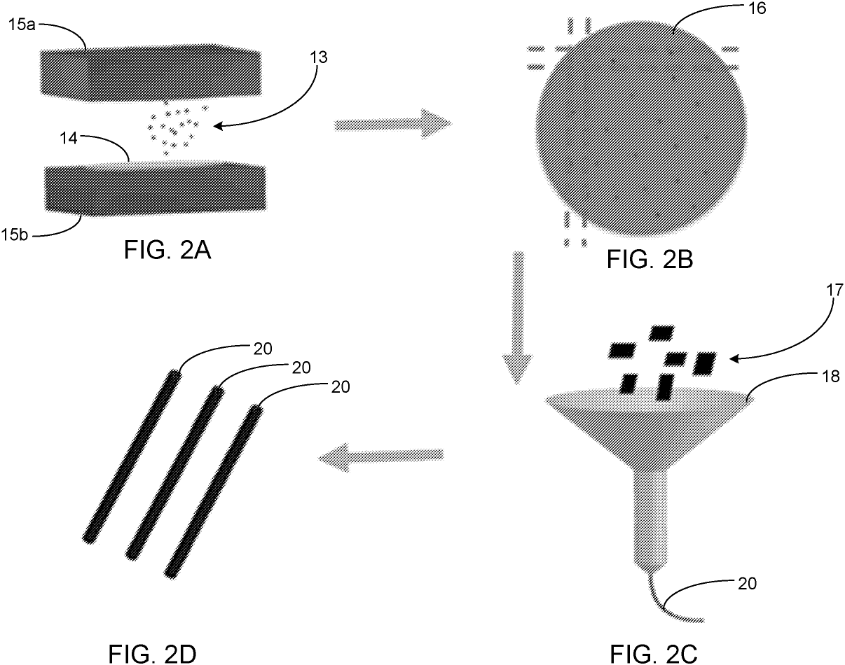

To develop the strain-sensitive electrically-conductive component, or electrodes, in accordance with a representative embodiment, a mixture of thermal plastic polymer and CB particles (CBs) can be used. Suitable TPEs include styrene and ethylene/butylene (SEBS) due to their high stretchability, good biocompatibility, and compatibility with the thermal drawing process. FIGS. 2A - 2D schematically illustrate the fabrication process for fabricating the stretchable electrodes in accordance with a representative embodiment. FIG. 2A shows the process by which the CB particles 13 are first embedded into a SEBS1 (Kraton, G1657) sheet 14 by compression in a hot press 15A, 15B. FIG. 2B is a top view of the compressed sheet 16 with the embedded CB particles, which is diced and then the die 17 are delivered to an extruder 18. FIG. 2C depicts the process of the die 17 (FIG. 2B) being received in the extruder 18, which extrudes a cylindrical preform 20 in which the electrode is embedded. FIG. 2D depicts three of the cylindrical preforms 20.

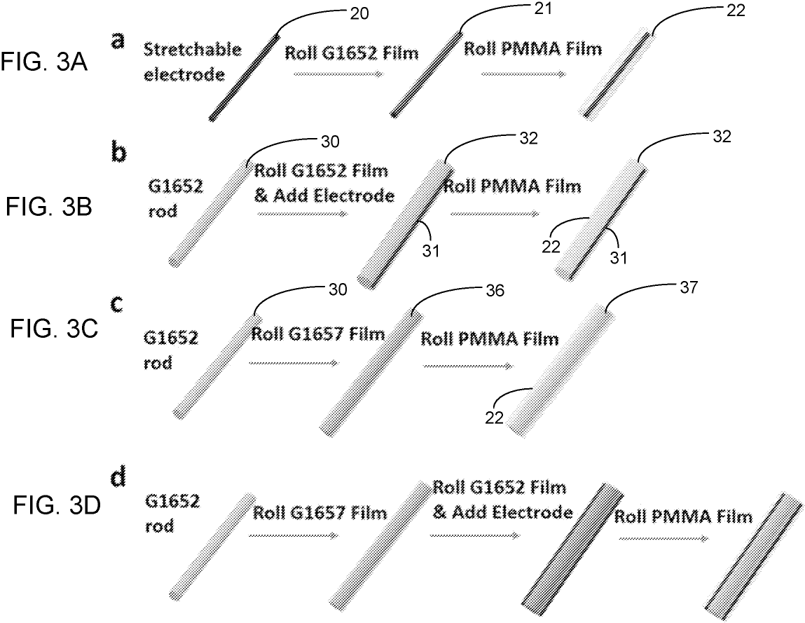

FIG. 3A depicts the process of preparing the cylindrical preform 20 in accordance with a representative embodiment. In accordance with an embodiment, the preform 20 having the stretchable electrode in the center is wrapped in an insulating layer 21 (e.g., SEBS2 (Kraton G1652)), and then is wrapped in a sacrificial PMMA film 22 that helps to hold the fiber shape during thermal drawing and that gets etched away after drawing. After that, the prepared preform 1 (FIGS. 1A or 1E) is mounted into a furnace 23 (FIGS. 1A and 1E) that can have three temperature zones and drawn into thin fibers 2 and 11 (FIGS. 1A and 1E) under applied high temperature and external stress. The drawn fiber can have the same cross-sectional geometry and composition as the preform 1, but with a significantly-reduced size, as shown in FIGS. 1A and 1E.

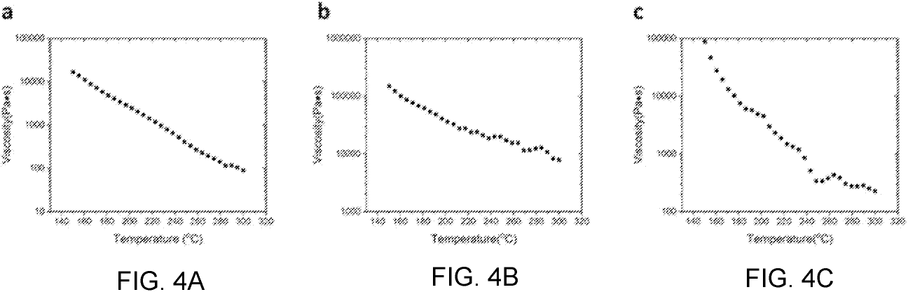

Figs. 4Aand 4B are plots of the Temperature vs. Viscosity characteristics of SEBS1 before and after loading it with 11 wt% CB, respectively. FIG. 4C is a plot of Temperature vs. Viscosity characteristics of SEBS2. A comparison of FIGS. 4A and 4B shows that the viscosity of the SEBS 1 increased by about 2 orders of magnitude at the drawing temperature (250° C. to 270° C.) after loading CB with a concentration of 11 wt%. With a higher loading concentration of CB, the viscosity at the processing temperature could be too high for the thermal drawing process. For this reason, the SEBS2 was chosen as the insulating layer for this experiment because of its higher viscosity compared with SEBS1, as can be seen by comparing FIGS. 4A and 4C. This can help to keep the fiber cross-section geometry more consistent with the preform during the thermal drawing process.

It should be noted that while SEPS1 and SEPS2 are suitable TPEs for this purpose under certain circumstances due to their high stretchability, good biocompatibility, and compatibility with the thermal drawing process, the inventive principles and concepts are not limited to using any particular TPEs for this purpose. Persons of skill in the art will understand how to choose a suitable TPE for the intended purpose.

For the fiber 2 depicted in the cross-section image shown in the top of FIG. 1B, the diameter of the fiber 2 after removing the sacrificial PMMA layer is about 360 µm, including a stretchable electrode core 3 with a diameter of about 210 µm, although the fiber 2 is not limited to having any particular dimensions, nor are the core 3 and sheath 4. The fiber diameter can be tuned from, for example, 100 µm to 1 mm by tuning the stress that is applied during the drawing process.

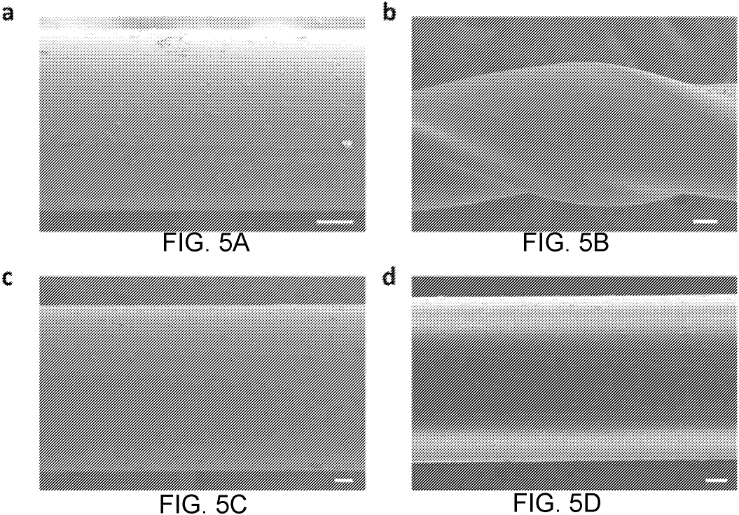

FIGS. 5A - 4D depict side-view SEM images showing surface morphology of, respectively, an electrical fiber sensor having a core-sheath structure, an electrical fiber sensor having a helix structure, stretchable optical fiber, and multifunctional fiber with optical waveguide and electrodes (scale bar: 100 um). It can be seen from these side-view SEM images that the surface of the prepared fiber is smooth with few small fragments, which might be PMMA residue left over from the etching process.

To improve the stretchability of the electrodes, researchers have investigated serpentine patterns in film-based electronics. In accordance with a representative embodiment, a similar 3-D helical structure is employed in the fibers to achieve large range strain sensing. FIG. 3B depicts the process of preparing the cylindrical preform in accordance with another representative embodiment to fabricate fibers having helical electrodes, as depicted in FIG. 5B. A stretchable electrode 31 is added near the edge of a TPE rod preform 30 (e.g., Kraton G1652) to obtain the preform 32, which is then wrapped, or rolled, in the sacrificial PMMA film 22. Helical fibers were then successfully drawn from the preform 32 with the help of a customized preform feeding stage that enabled simultaneous translational and rotational motion of the preform (FIG. 1E). The periodicity of the helix patterns was controlled by the drawing speed and the rotation speed. After drawing the fiber, the film 22 was removed via etching.

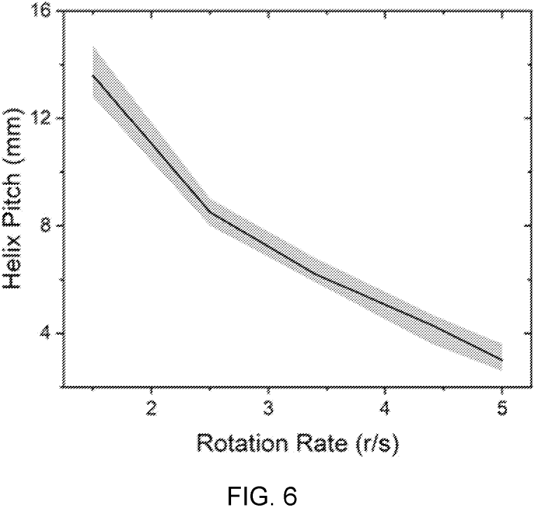

Similarly, with two stretchable electrodes 31 disposed on opposite sides of the preform 33, double helix patterns of the type shown in FIG. 1F can be produced. The pitch of the double helix patterns decreased when the rotation speed was increased. FIG. 6 is a plot of the rotation rate during the drawing process vs. the helix pitch that shows the relationship between the pitch and the rotation speed when the drawing speed was fixed at 85 cm ·min⁻¹. The smallest pitch of the helix patterns achieved was 2.8 mm for a fiber with a diameter of 850 µm and the corresponding rotation rate of the preform 32 was 5 r · s⁻¹. With the soft polymer material used in the experiment at a high temperature, the fiber would break at a higher rotation rate due to the high torsion applied, although this could be prevented by using a different polymer and/or by adjusting other drawing conditions. The length of the stretchable electrode 31 in the helical fiber can be much longer than that in the straight fiber (e.g., 1.4 times longer). Therefore, the helix pattern reduced the stress applied on the stretchable electrode when the fiber was stretched, which increased the stretching range of the fiber strain sensor. A comparison of FIGS. 1D and 1H shows that when the respective fibers were stretched by 750%, the electrode 26 of the straight fiber broke into pieces while the electrode of the helical fiber remained intact.

### 2.2 Electrical and Mechanical Properties of the Electrical Fibers

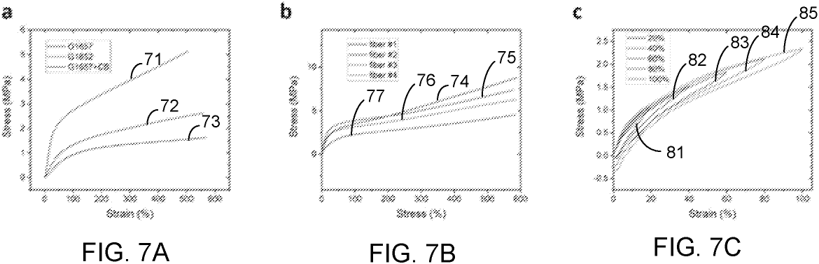

To validate the potential use of the stretchable fibers as strain sensors, electrical and mechanical tests were performed, as will now be described. The resistivity of the stretchable electrode was 0.219±0.041 Ω▼m before thermal drawing while the resistivity was 0.245±0.062 Ω▼m after thermal drawing (n=5). The t-test between these two groups exhibited a p-value of 0.4354, demonstrating there is no significant variation of the conductivity of CB loaded SEBS during the thermal drawing process. FIG. 7A shows stress-strain curves 71 - 73 for preform materials G1657, G1652 and G1657 + CB, respectively. FIG. 7B shows stress-strain curves 74 - 77 for, respectively, an electrical fiber sensor with a core-sheath structure, an electrical fiber sensor with a helix structure, a stretchable optical fiber and a multifunctional fiber with optical waveguide and electrodes. FIG. 7C shows stress-strain curves 81 - 85 of the fiber strain sensors for, respectively, applied strains of 20%, 40%, 60%, 80% and 100%, showing the mechanical hysteresis of the sensor according to the various applied strains.

The stress-strain curves shown i8n FIG. 7A of the stretchable electrode used in the preform indicate that the CB-loaded SEBS had a higher Young’s Modulus (~2.12 MPa) than the unloaded preforms (~0.98 MPa). Also, none of the preforms made of the three materials (G1657, CB loaded G1657 and G1652) broke under an applied strain of 550%. After thermal drawing, both the core-sheath fiber sensor and the helical fiber sensor could survive a 580% strain, as shown in FIG. 7B.

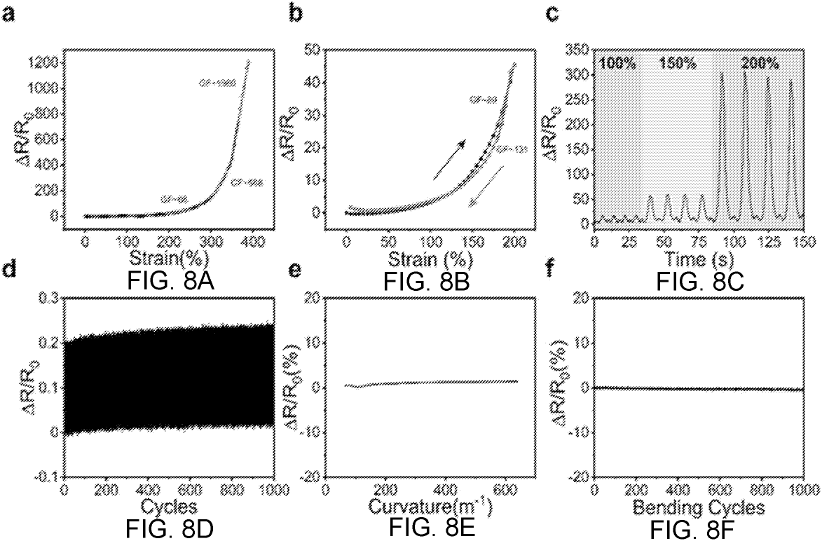

FIGS. 8A - 8F are curves showing different electrical characterization of the fiber sensors. FIG. 8A is a plot of resistance change ΔR/R₀ = (R -R₀)/R₀, where R is the measured resistance, and R₀ is the original resistance before stretching) as a function of the tensile strain (quasi-static loading). as a function of the applied strain. FIG. 8B is a plot of the hysteresis performance of the fiber sensor. FIG. 8C is a plot of the normalized resistance changes of the strain sensor against repeated strains of 100, 150, and 200%. FIG. 8D is a plot of stability of the resistance response of the fiber strain sensor to the repeated strains of 40% over 1000 cycles. FIG. 8E is a plot of the relative resistance change of the fiber sensor as a function of curvature. FIG. 8F is a plot of stability of the resistance response of the fiber strain sensor to the repeated bending curvature of 100 m⁻¹ over 1000 cycles.

It can be seen from FIG. 8A that as the applied strain increased, the electrical resistance of the fiber strain sensor increased rapidly due to the loss of the electrical connections between the nanoparticles. The gauge factor of the fiber strain sensor, obtained as the slope of the curve in FIG. 2a, is defined as GF = δ((R - R₀)/R₀)/δε, where ε is the applied strain. The fiber strain sensor roughly exhibited GFs of ~66 for the strain range of 100 - 250%, ~568 for 300 - 350%, and ~1960 for 380 - 400%. These results demonstrate that the fiber strain sensors have a high sensitivity within a large sensing range. FIGS. 8B and 7C show that the fiber sensor presented a slight hysteresis of resistance and stress during the stretching-releasing process, which can be owing to the viscoelasticity of SEBS. What’s more, the GF (~131) during releasing was larger than the GF (~89) during stretching, which can be attributed to the lower stress during the releasing process. Some conductive pathways could disconnect because of the low stress when the fiber was released to the low strain range.

To confirm the reliability of the fiber sensors, dynamic tensile strains were applied with different amplitudes (100 - 200%) to the fiber strain sensor. As shown in FIG. 8C, the relative change in resistance showed a stable and distinguishable signal without observable degradation for various tensile strains of 100%, 150% and 200%. In addition, the durability and stability tests of the fiber strain sensor show that the resistance exhibited good repeatability during the 1000 cycles under 40% strain (FIG. 2d).

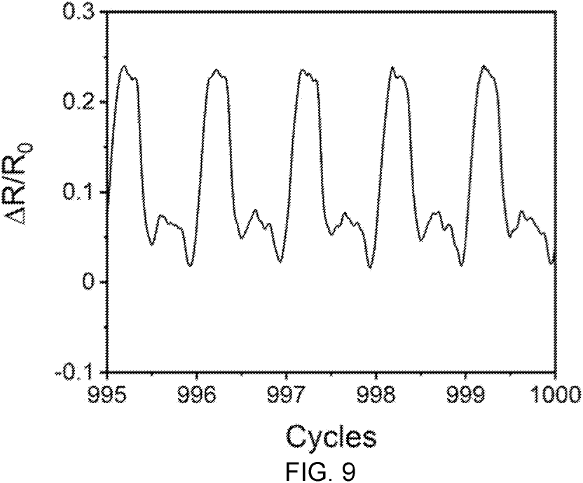

FIG. 9 is a plot of resistance change ΔR/R₀ = (R -R₀)/R₀ as a function of the applied strain for the last five cycles. The last five cycles shown in FIG. 9 indicate good repeatability of the fiber strain sensor. The small side peaks can be explained by the reconnection and disconnection of conductive paths when the fiber was stretched or released in the reversible section where the stress is insufficient to connect all the pathways perpendicular to the axial direction. If measurement of small strain deformation is needed, the fiber sensors can be slightly prestretched to skip the reversible section. Besides, as shown in FIG. 8E, the resistance change of the fiber sensor was less than 2% with mechanical bending ranging from 0 to 640 m⁻¹, suggesting no significant influence of the bending to the conductive paths. In addition, the resistance change was less than 1% during 1000 cycles under 100 m⁻¹ bending curvature, as shown in FIG. 8F, indicating good durability of the fiber strain sensor under mechanical bending.

### 2.3 Stretchable Optical and Multifunctional Fibers

Similarly, stretchable optical fibers for deformation sensing were fabricated using the thermal drawing process. FIG. 3C shows preparation of the preform in which SEBS1 films 36 were rolled on a SEBS2 rod 30, followed by several layers of PMMA films 22 to create preform 37. Because the refractive index of SEBS1 (1.48) is slightly smaller than that of SEBS2 (1.51), an optical waveguide is formed. After the drawing process, the PMMA layer was etched away to expose the stretchable optical fiber. The diameter of the stretchable waveguide could be altered from 0.2 to 1 mm with controlled stress and preform feeding speed. The fibers’ cross-section with light transmission is shown in FIG. 3a. The transmission is predominantly from the core, indicating light guiding by the total internal reflection. The edge of the fiber core was not perfectly smooth, which can be explained by the viscosity mismatch between the core and cladding during the drawing process. Nonetheless, the core was totally surrounded by the cladding along the fiber, thus enabling continuous light guiding.

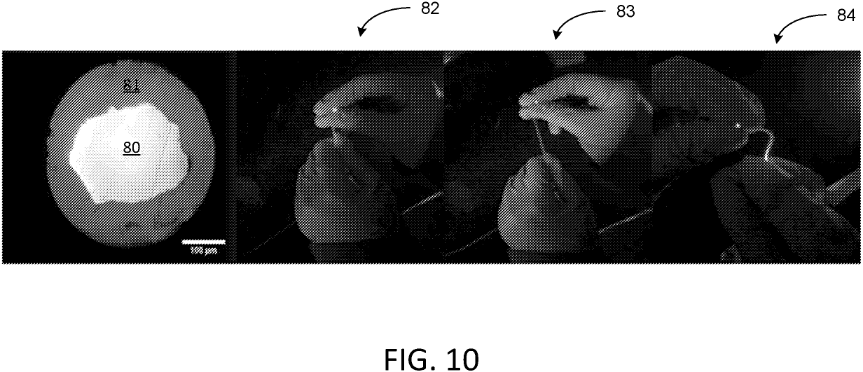

FIG. 10 shows an optical image of an end face of a stretchable optical waveguide in accordance with a representative embodiment as well as the same fiber guiding light in it original (image 82), stretched (middle image 83) and bent (right image 84) states. In accordance with this embodiment, the stretchable optical waveguide comprises a stretchable polymer fiber comprising a TPE core 40 having a first refractive index surrounded by a TPE cladding 41 having a second refractive index. The second refractive index is lower than the first refractive index such that light is mainly concentrated in the core. The fiber is capable of transmitting light when it is stretched or bent, but stretching or bending the fiber changes the amount of optical loss that the light being carried along the fiber experiences. The optical loss can be measured using an optical detector, such as a P-intrinsic-N (PIN) diode, for example, and the amount of strain on the fiber can be determined based on the measured optical loss. The PIN diode outputs an electrical current that can be measured by suitable measurement instrument, e.g., an ammeter, a voltmeter, etc., to determine the change in the electrical current launched into the fiber and the electrical output from the opposite end of the fiber. The amount of optical loss can be determined from the change in the electrical current.

Although plastic optical fibers are known that are used for optical communications, such fibers typically have low stretchability, i.e., less than about 5%. The core is typically made of PMMA and the cladding is typically made of silicone. In contrast, stretchable optical waveguides of the present disclosure can have a stretchability that can range from, for example, 150% to more than 600%. The stretchability of the stretchable fibers of the present disclosure will be selected based on the application.

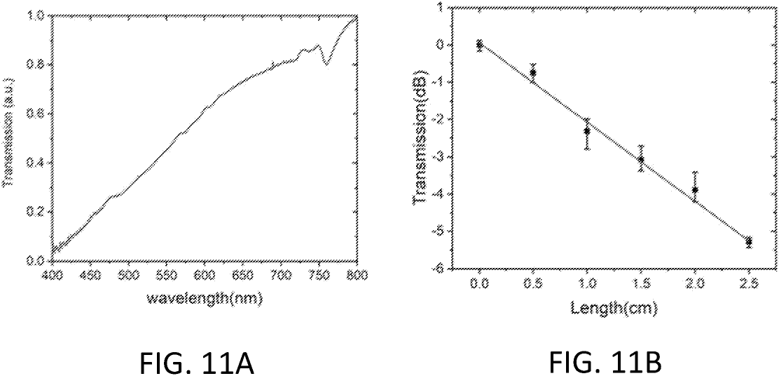

FIGS. 11A - 13B demonstrate the performance of the stretchable optical waveguide shown in FIG. 10. Transmission spectroscopy was performed to confirm the utility of the stretchable optical waveguide for optical guidance in the visible range (400 nm to 800 nm). FIGS. 11A and 11B demonstrate the optical transmission and loss, respectively, as a function of wavelength and length, respectively. The fiber loss is about 2.1 decibel (dB)/centimeter (cm) at the wavelength of 735 nm (FIG. 11B).

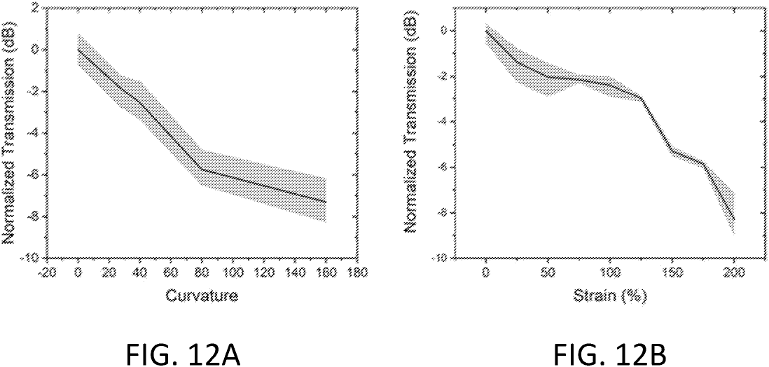

FIGS. 12A and 12B show the normalized optical transmission as a function of curvature and percentage strain, respectively. When the optical waveguide is bent, the number of optical modes in the fiber decrease because of radiation loss at the bending site, and therefore the transmission of the fiber also decreases. Similarly, when the fiber is stretched, the length of the fiber increases and the diameter of the core decreases, which decreases the number of modes in the fiber and increases the length of the light propagation path, thereby decreasing the transmission intensity. One or both of these two phenomena can be used for touch or strain sensing in accordance with the inventive principles and concepts of the present disclosure.

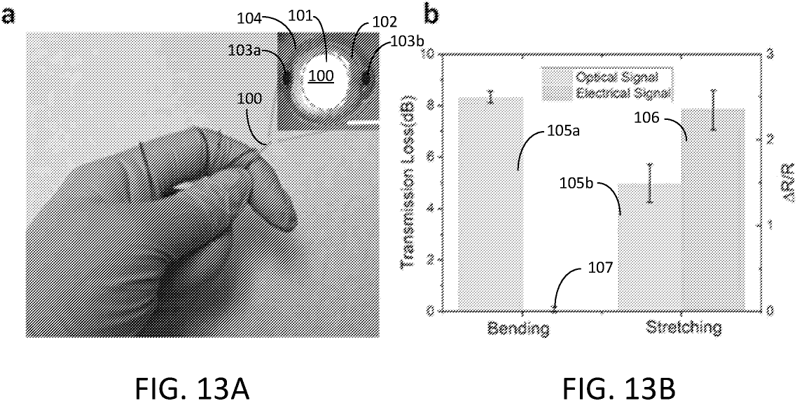

Beyond the resistance-based fiber strain sensors and stretchable waveguide-based fiber deformation sensors discussed above, multifunctional, multi-material fibers with stretchable optical waveguides with one or more electrodes can be fabricated to take advantage of these two mechanisms, i.e., determining strain based on the change in electrical resistance and based on the change in optical transmission or loss. FIG. 13A is a photograph of such a stretchable optical waveguide 100 having two electrodes in accordance with a representative embodiment. The stretchable optical waveguide with one or more electrodes is referred to hereinafter as a “stretchable optical/electrical (O/E) fiber.” FIG. 13A also shows a photo of an end view of the stretchable fiber optical waveguide 100 having first and second electrodes 103a and 103b, respectively. (Scale bar: 300 µm). The fiber 100 is soft and scalable and can be wrapped around a human finger, as shown in FIG. 13A. The cross-sectional image shown in FIG. 13A shows that the fiber 100 has a TPE core 101, a TPE cladding 102 and first and second electrodes 103a and 103b, respectively, encapsulated in an outer encapsulation 104. Integratating the stretchable O/E fiber 100 enables a single-fiber center to perform simultaneous electrical and optical sensing.

FIG. 13B shows the performance of the stretchable O/E fiber 100 shown in FIG. 13A in terms of optical transmission loss as a function of bending and in terms of relative resistance as a function of stretching. In FIG. 13B, bars 105a and 105b correspond to transmission loss as a function of bending and stretching, respectively, and bar 106 corresponds to relative resistance as a function of stretching. The very small bar 107 corresponds to relative resistance as a function of bending, and demonstrates that bending has very little influence on the electrical signal. The optical and electrical components of the stretchable O/E fiber 100 responded to 100% strain (bars 105a, 105b and 106) while only the optical component of the fiber 100 responded to bending curvature of 320 m⁻¹ (bar 105a). Thus, with the stretchable O/E fiber 100, it possible to distinguish and quantify stretching and bending using a single-fiber sensor.

The fiber could withstand a strain of 580% (FIG. 7B) and guide the light when it was stretched and bent (FIG. 10). To characterize the optical performance of the fibers, they were coupled with a white light source and the transmission spectrum is shown in FIG. 11A. In the wavelength range of 400-800 nm, the optical fibers generally showed higher transparency at longer wavelengths due to the material scattering and absorption, corresponding to other reported TPE fibers. The propagation losses of optical fibers measured by the cutback method are shown in FIG. 11B. The attenuation coefficient was 2.2 dB/cm, which is consistant with stretchable optical fibers in other reported works. The loss of the fibers can be caused by defects at the fiber core or at the core-cladding interface, such as dust, voids or inconsistent core geometry. The impact of stretching on the light transmission characteristics of the fibers was also tested and quantified. As shown in FIG. 12A, the output power loss of the fibers increased with growing strain due to the increase of optical path length through the attenuating medium. Besides, the output power loss induced by different bending curvatures were also investigated (FIG. 12B). When the bending curvature was tuned from 0 to 320 m⁻¹ gradually, the output power loss increased, which can be explained by radiation losses.

In addition to resistance-based fiber strain sensors and stretchable waveguide-based fiber deformation sensors, multifunctional multi-material fiber with a stretchable waveguide and electrodes were also fabricated to combine the advantages of these two mechanisms. The preform fabrication process in accordance with this representative embodiment is shown in FIG. 3D, which is the same as the process depicted in FIG. 3C except that FIG. 3D includes the steps of adding the electrode and rolling it in the G1652 film 38 pror to the PMMA rolling step to complete the preform 39. The drawn fiber is highly flexible and scalable, and it can be wrapped around a human figure (FIG. 13A). The cross-sectional image shows that the fiber comprised of one stretchable optical waveguide and two electrodes, which enabled simultaneously electrical and optical sensing via a single fiber. This fiber could withstand a 580% strain according to the mechanical test shown in FIG. 7B. As shown in FIG. 13B, both stretchable waveguide and electrode responded to the 100% strain while the waveguide alone responded to a bending curvature of 320 m⁻¹, enabling it to distinguish and quantify stretching and bending with a single device.

### 2.4 Smart Gloves, Wrist Brace and Strain Mapping

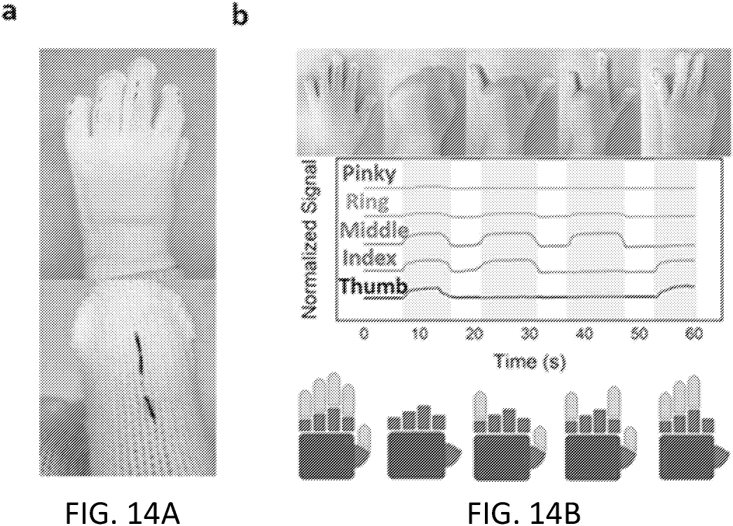

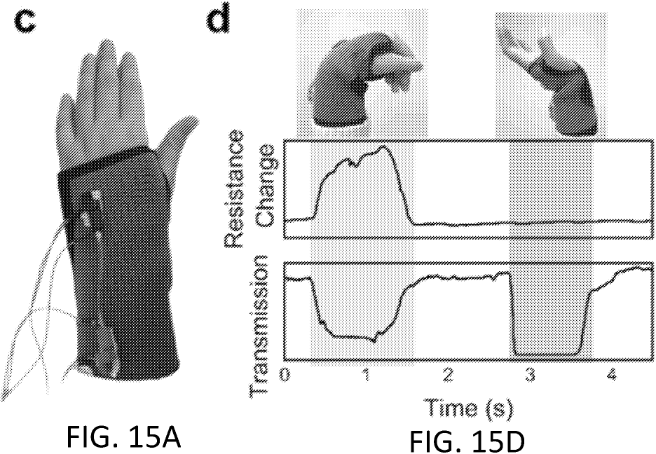

To demonstrate the applicability of these fiber sensors for wearable electronics and human-machine interfaces, smart gloves were manufactured by handweaving electrical fiber sensors into commercial gloves, as shown in FIGS. 14A and 14B. A wrist brace was also manufactured in a similar manner, as shown in FIGS. 15A and 15B. The resistance-based fibers of the type described above with reference to FIGS. 1A - 1D were incorporated into the fingers and thumb of the glove. FIG. 14B shows normalized electrical signals sensed for five different hand gestures made by a user wearing the glove on the left hand. The upper portion of FIG. 14B shows photos of the five different hand gestures and the lower portion of FIG. 14B shows corresponding drawings of the five different hand gestures. The middle portion of FIG. 14B shows a timing diagram for the five measured electrical signals. It can be seen from the timing diagram that each of the five different hand gestures resulted in a unique combination of the set of measured electrical signals, thus making it possible to determine which hand gestures was made based on the set of measured electrical signals. FIG. 15D also shows plots of the resistance and light transmission responses of the fiber sensor with wrist flexion and extension.

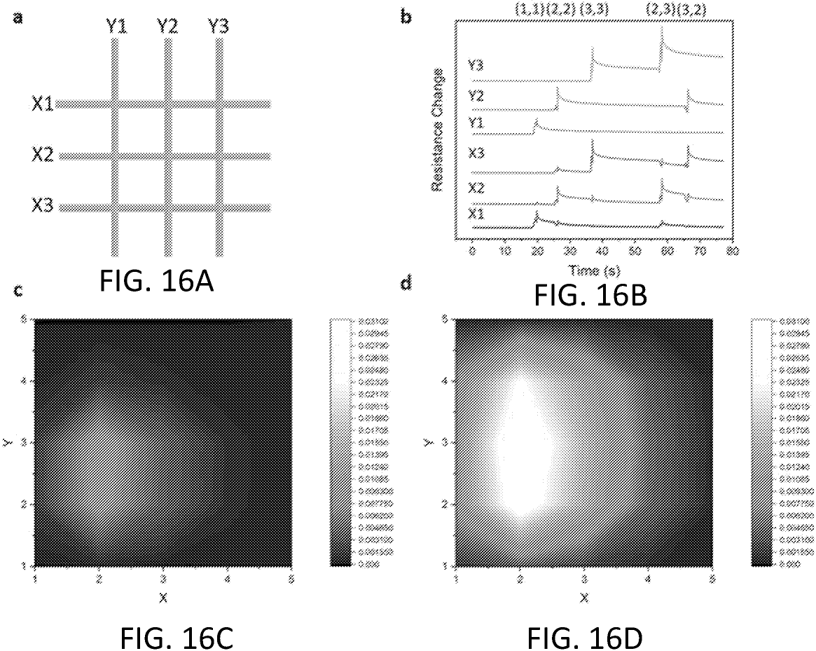

FIGS. 16A - 16D show the strain-sensing performance of a mesh having six of the resistance-based fibers of the type shown in FIG. 1A woven into it in a 3x3 pattern. FIG. 16A is a schematic illustration of the 3×3 fiber mesh. FIG. 16B is a timing diagram that shows the relative resistance change of the six measured sensor signals for the six respective fibers in the mesh when the mesh is pressed at different locations by a human finger. FIGS. 16C and 16D show the reconstructed strain mapping when a stainless steel ball with a diameter of 25 mm and 31 mm, respectively, is placed on the mesh. Based on the measured sensor signals, the location of the impact of the finger or the stainless steel ball can be automatically determined. FIGS. 16A - 16D demonstrate that the resistance-based strain sensor can be woven into mesh to allow two-dimensional (2-D) information to be obtained from the sensed signals. When the mesh is pressed at a particular location, both the location and intensity information can be obtained based on the resistance change (FIG. 16B). Also, strain mapping can be performed to distinguish the shape of different objects placed on strain mesh.

### 2.5 Bladder Volume Sensing and Biocompatibility

Neurogenic bladder dysfunction resulting from various neurological diseases and disorders negatively affects the quality of life of many people and can cause renal failure. Therefore, a technology that can monitor the real-time deformation of the bladder (e.g., expansion) is highly desired. However, monitoring bladder volume is challenging using conventional planar devices due to its high elasticity, the magnitude of cyclic strain changes, and freeform anatomical geometry. Most established methods for characterizing bladder deformation are based on localized measurements and often monitor bladder volume based on information from one point or one direction. While these approaches offer useful techniques under controlled settings, the complex geometry and surface topography can introduce measurement challenges and uncertainty that impede clinical use. The fiber mesh of the present disclosure is a promising solution to monitor bladder volume change in vivo due to its high sensitivity, large strain range, and spatiotemporal monitoring capability.

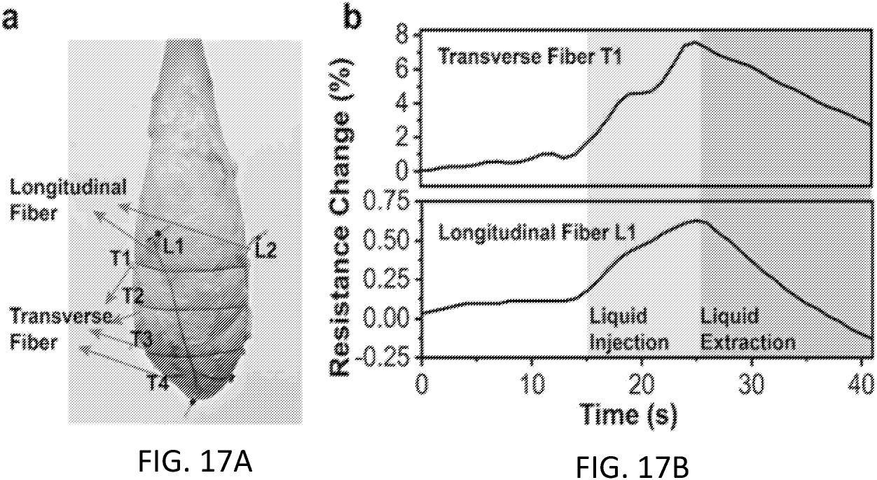

To validate the potential application of our fiber mesh, we fitted a 4x4-fiber strain sensing mesh to a porcine bladder (FIG. 5a) and connected it to the measurement system. FIG. 17A is a photograph of a pig bladder having a fiber mesh mounted thereon comprising four transverse and two longitudinal resistance-based fibers of the type described above with reference to FIGS. 1A - 1D for sensing expansion and shrinkage of the bladder in different directions as liquid is injected into and extracted from the bladder. FIG. 17B shows the resistance change of a transverse fiber at the middle of the bladder (fiber T1 in FIG. 17A) and a representative longitudinal fiber (fiber L1 in FIG. 17A) when 400mL water was injected and subsequently removed from the bladder.

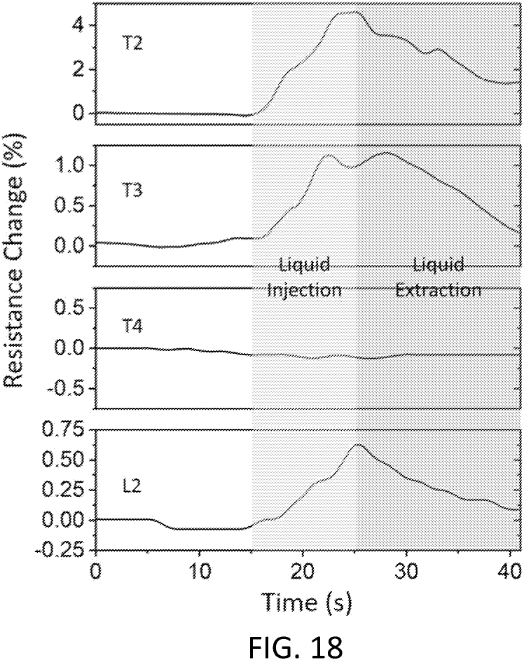

FIG. 18 shows the resistance response of fibers T2, T3, T4 and L2 when 400 mL water is injected and subsequently removed from the bladder manually. The resistance change of the transverse fiber in the middle (T1) was about 7% between water fill-up and drainage, while that for longitudinal fibers L1 and L2 was only about 0.7%. As expected, the resistance variations of other transverse fibers (T2, T3, T4) were smaller than T1. These results demonstrated the sensing capability of the fiber sensors to monitor multiaxial bladder expansion and contraction, which can help provide accurate information for bladder volume monitoring and disease diagnosis.

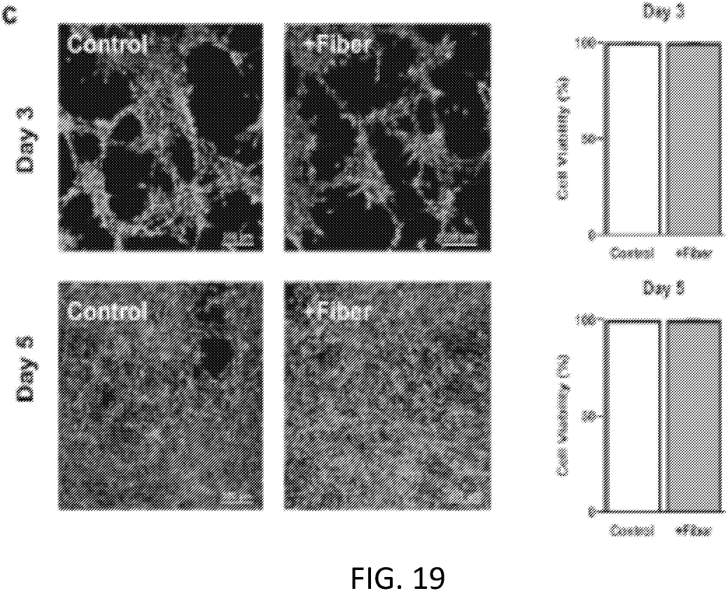

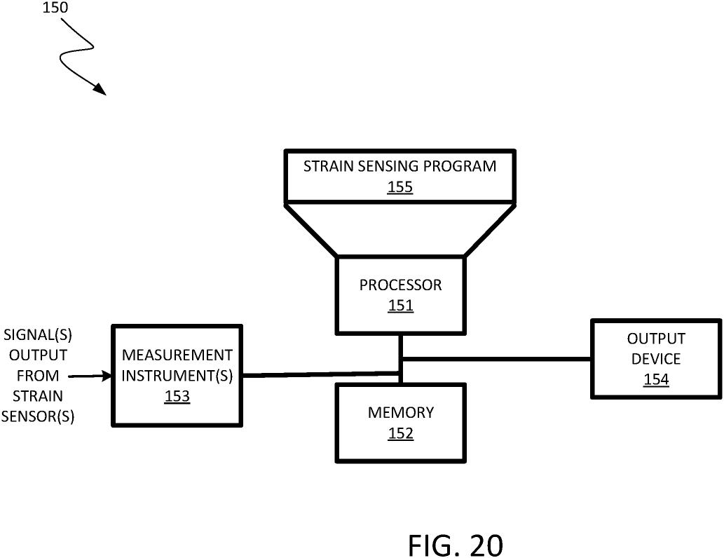

The biocompatibility of the fiber strain sensors was also evaluated by a live-dead test using mouse embryonic fibroblasts (NIH/3T3). FIG. 19 shows live-dead test results using mouse embryonic fibroblasts (NIH/3T3) after 3 and 5 days. In these experiments, there is no significant difference in cell visibility between the control and cultures with fibers present on Day 3 (p=0.4046) and Day 5 (p=0.5457), which suggests that the fiber is highly biocompatible and does not impact cell viability.

### 3. Conclusion

A scalable approach for fabricating stretchable electrical and optical fiber sensors for multimodal extreme deformation sensing has been demonstrated herein. The fiber sensors involved in the experiments were shown to withstand extremely high elastic deformation (e.g., at least 580%) and strain (e.g., up to 750%) with a helical structure. The electrical fiber sensors can have a high GF (e.g., ~ 1950), a very broad strain-sensing range (e.g., 400%), and high durability over 1000 stretching and bending cycles. In addition, the stretchable step-index core-cladding optical fibers can guide light and are sensitive to deformations including stretching and bending. Integrating stretchable electrodes and waveguides, multifunctional fiber sensors are capable of quantifying and distinguishing multimodal deformations. To demonstrate the applicability of these fibers to wearable and textile electronics, they were integrated into a glove to detect hand motions and control a virtual hand model, attached to a wrist brace to track wrist movements, and woven the sensors into meshes to sense and locate arbitrary objects. In addition, the fiber sensors could be candidates for biomedical implantable devices as they can effectively monitor multiaxial expansion and shrinkage of a porcine bladder and show good biocompatibility. These thermally drawn stretchable fiber sensors are promising candidates for developing next-generation applications such as wearable electronics, human-machine interface, biomedical implantable devices and robotics.

### 4. Experimental Section

Synthesis of CB Composite: SEBS1 (G1657, Kraton) pellets were pressed into sheets at 180° C. using a hot press (MTI Corporation) and the sheets were weighted. CBs were weighed for 11 wt% loading and then sprinkled between SEBS1 sheets. Next, the SEBS1 sheets with deposited CBs were pressed in a hot press at 180° C. and 50 bar for 10 min to embed the CB into SEBS1 sheets. We got a relatively thick CB-loaded SEBS1 sheet. The obtained sheet was then folded and pressed in a hot press at 180° C. and 50 bar for 10 min. To make a homogeneous dispersion of CBs in SEBS1, we repeated the folding and pressing process for 8 cycles. Then, the sheet was chopped into 1 mm × 1 mm pieces and extruded in a single-screw extruder (Dynisco) with a 3 mm circular dye to achieve high-quality mixing of the CBs in SEBS1.

Fiber Fabrication: Preforms with different materials and geometries were fabricated as shown in FIG. S3. The overall diameters of the preforms were all around 25-30 mm, and the lengths were 150 mm. Then, the preforms were drawn at temperatures of 150° C. (top), 260° C. (middle), 120° C. (bottom) into fibers with kilometers in length using a custom-built fiber drawing tower. The PMMA (Rowland Technologies) sacrificial layer was etched using acetone (Sigma-aldrich) afterward.

Electrical, Optical, and Mechanical Characterization: The electrodes of fibers were connected to copper wires (Mcmaster-Carr) using conductive epoxy (MG Chemicals) and insulated using 5-min epoxy (Devcon). The electrical resistance of the fiber strain sensor was measured using a programmable electrometer (Keithley 6514), and the data were exported by a data acquisition (DAQ) device (National Instrument, USB-6211) and LabVIEW programs. A linear motor (LinMot E1200) was used to control the strain applied to the fibers. The optical images of the fiber sensors were characterized by a microscope (Axiovert 25). To obtain the optical transmission spectra, we connected a halogen light source (DH1000, Ocean Optics) to the optical waveguide using the ferrule-to-ferrule coupling method. The transmitted light was collected at the other side of the fiber with a fiber-coupled spectrometer (Flame, 200-1,025 nm, Ocean Optics). The normalized transmission spectra were calculated by, I_{normalized} = (^{I}sample -Iₙₒᵢₛₑ)/(I_{source} - Inoise) and normalized by the maximum value. Iₛₐₘₚₗₑ, Iₙₒᵢₛₑ and I_{source} are the transmission spectra of fiber, noise, and light source. For optical fiber loss, strain sensing, and bending sensing measurement, the stretchable optical fibers were connected to a laser with a wavelength of 735 nm (TLB-6700, Newport) and the light output was measured by a power meter (Thorlabs) with a photodetector (Thorlabs) attached. The output power losses were calculated by, I_{output power} ₗₒₛₛ(dB) = -10log(I_{stretched/bent} /Iᵢₙᵢₜᵢₐₗ), where lᵢₙᵢₜᵢₐₗ , I_{stretched/bent} are the output power intensities of the fibers before and after stretching or bending. Mechanical stress-strain tests were measured using a dynamic mechanical analysis (DMA Q800, TA instruments).

Fiber-Based Sensors Testing: All the fibers used in testing were pre-stretched to 10% to skip the reversible section. For the smart gloves, five fiber sensors were hand-woven into a commercial knitted glove. The voltage recording from the gloves were filtered with an anti-aliasing filter at 400 Hz and sampled at 1000 Hz using a National Instrument Data Acquisition System (Ni-Daq). Real-time data plots and hand animation were realized with customized Matlab scripts. The buffer size was set to 50 elements and the display of graphical user interface (GUI) was updated at 10 Hz. The signals from each finger were filtered with a low-pass infinite impulse response (IIR) filter and a notch filter (60 Hz and harmonics) to smooth the signals in time domain. We implemented four different states and two inputs (differences of max and min and slopes) to create a simple finite state machine for each finger’s orientations. Each state corresponds to a finger flexing, a finger flexed, a finger releasing, and a finger released. The stretchable waveguide inside the fiber was connected to a red LED (Industrial Fiber Optics E96E) as the light source and a photodiode (Industrial Fiber Optics D91B) as a detector. The current generated by the photodiode was amplified and converted to a voltage signal via an operational amplifier circuit and recorded using Ni-Daq. During the hand gesture and wrist movement detection, the LED and photodiode on both ends of the fibers were attached on a commercial knitted glove and wrist brace using double-sided tape (3M) and epoxy (Devon). For the fiber mesh, two ends of each fiber were fixed on a home-made wood frame using epoxy (Devcon). The resistance changes (ΔR/R₀) from the row and columns were arranged in two vectors, and the two-dimensional outer product of these one-dimensional vectors was calculated, producing a 5 × 5 matrix. For bladder sensing, a fiber mesh was mounted on a pig bladder and connected to a measurement circuit. 400mL water was injected and extracted mannully using 60 mL syringes.

Cell culture: Mouse embryonic fibroblasts (NIH/3T3, ATCC) were cultured in DMEM/F12 (ThermoFisher) supplemented with 100 U mL⁻¹ penicillin-100 µg mL⁻¹ streptomycin and 10% v/v FBS in a 37° C. and 5% CO₂ incubator. The 3T3 cells were grown as adherent cultures and were passaged with Typsin-EDTA (ThermoFisher) solution at 90% confluency.

LIVE/DEAD Viability Assay: 3T3 fibroblasts were plated at 1.5x 10⁵ in 100 mm culture dishes and the following day eight ~1cm fiber sections were added to half of the plates. Cell viability was assessed with a LIVE/DEAD Assay (ThermoFisher) following manufacturer’s instructions on Day 3 and Day 5 following fiber addition. In brief, the cultures were incubated in a 2 µM calcein AM and 4 µM EthD-1 solution for 30 minutes at 37° C. with 5% CO₂. The cultures were then washed with cell medium and imaged.

Imaging and analysis of cell viability: By using a laser-scanning microscope (A1R; Nikon) equipped with a Plan Apo 10 × /N.A 0.45 air objective, we acquired images of both culture conditions. Five independent fields of view were imaged per sample for each condition. Quantification of the percentage of cells that were viable was performed with ImageJ Fiji software. In short, the total volume of cells (green signal from calcein AM plus red signal from EthD-1) was calculated by creating a binary of the fluorescent signals. Subsequently, the percentage of viable cells was obtained by dividing the calcein AM (green signal) volume from the calculated total volume.

FIG. 19 is a block diagram of a strain sensor system 150 in accordance with a representative embodiment that processes the signals that are output from any of the strain sensors described above with reference to FIGS. 1A - 18 to determine the strain exerted on the strain sensor. The system 150 comprises a processor 151, a memory device 152, one or more measurement instruments 153 and an output device 154. The processor 151 is configured to execute and strain sensing algorithm 155, which is typically a software and/or firmware computer program comprising computer instructions that are stored in a non-transitory computer readable medium, represented in FIG. 15 by memory device 152. The signal(s) that are output from the strain sensor(s), which may be optical and/or electrical, are measured by the measurement instrument(s) 153 (e.g., ammeter, voltmeter, PIN diode, etc.) and converted into digital signals by an analog-to-digital converter (not shown), which may be part of or separate from the measurement instrument(s) 153.

The processor 151 executing the strain sensing program 155 processes the digital signals and converts them into one or more measurements of strain exerted on the strain sensor(s). The design of the strain sensing program 155 can vary based on a number of factors, such as, for example, the application for which the strain sensor(s) is used, the configuration of the strain sensor(s), the number of strain sensors employed, whether the strain sensor includes an optical waveguide and or one or more electrodes, etc. The processor 151 causes the strain measurements to be output to the output device 154, which may be, for example, a display device, a printer, a control system of a robotic device or prosthetic device, a telemedicine database, a physiological condition monitoring device, etc.

The system 150 may be part of a wearable device that incorporates the strain sensors or it may be partially or wholly separate from the wearable device. For example, the processor 151, the memory device 152 and the measurement instrument(s) may be mounted on or woven into the wearable device, whereas the output device 154 may be remotely located. As another example, the measurement instrument(s) may be part of the wearable device that incorporates the strain sensor(s), whereas the processor 151, the memory device 152 and the output device 154 may be collocated at some other location (e.g., a hospital or doctor’s office).

It should be noted that the processor 151 executing the strain sensing algorithm 155 can computer the strain measurement based on the digital signals output from the measurement instrument(s) 153 or it can use the digital signals as addresses in a lookup table (LUT) contained in memory device 152. A LUT can be created based on experimental data that correlates digital signals output from the measurement instrument(s) 153 with calculated strain values. Using a LUT in this manner can expedite the process of converting the digital signals into strain measurements.

### ASPECTS IN ACCORDANCE WITH INVENTIVE PRINCIPLES AND CONCEPTS

Various inventive aspects are discussed above and recited below in the claims. In accordance with one aspect, a strain sensor is provided that comprises a stretchable polymer fiber, at least a first electrode and at least a first measurement instrument. The first electrode is disposed in or on the fiber and extends in a direction generally parallel to a longitudinal axis of the fiber. Strain exerted on the fiber changes an electrical resistance of the first electrode. The first measurement instrument is electrically coupled to the first electrode. The measurement instrument measures the change in electrical resistance and determines the strain exerted on the fiber based at least in part on the measured change in resistance.

In accordance with another aspect, the stretchable polymer fiber is a stretchable TPE fiber.

In accordance with another aspect, the first electrode comprises regions in the stretchable polymer fiber, such as, for example, polyethylene (PE), polyvinylidene fluoride (PVDF), polycarbonate (PC), poly(methyl methacrylate) (PMMA), and stretchable thermal plastic elastomer (TPE), that are doped with electrically-conductive (EC) particles that form EC paths in the fiber when the fiber is in an unstretched state.

In accordance with another aspect, the EC particles are carbon black (CB) particles.

In accordance with another aspect, the doped polymer fiber is stretched, one or more of the EC paths disconnect, thereby increasing the electrical resistance, and wherein when the stretching force exerted on the polymer fiber is released, the EC paths reconnect, thereby decreasing the electrical resistance.

In accordance with another aspect, the first electrode comprises an EC liquid disposed in at least a first channel formed in the fiber.

In accordance with another aspect, when the fiber is stretched, the length of the EC liquid increases and a cross-sectional area of the EC liquid decreases, thereby increasing the electrical resistance of the electrode, and when the stretching force is released, the length of the EC liquid decreases and the cross-sectional area of the EC liquid increases, thereby decreasing the electrical resistance of the electrode.

In accordance with another aspect, said at least a first electrode further comprises at least a second electrode comprising the EC liquid disposed in a second channel formed in the fiber. When the fiber is stretched, a length of the EC liquid disposed in the second channel increases and a cross-sectional area of the EC liquid disposed in the second channel decreases, thereby increasing the electrical resistance of the second electrode. When the stretching force is released, the length of the EC liquid disposed in the second channel decreases and the cross-sectional area of the EC liquid disposed in the second channel increases, thereby decreasing the electrical resistance of the second electrode, said at least a first measurement instrument measuring the change in electrical resistance and determining the strain exerted on the fiber based at least in part on the measured change in electrical resistance.

In accordance with another aspect, the fiber comprises core and at least a first cladding. The core comprises a stretchable polymer having a first refractive index and the first cladding comprises a stretchable polymer having a second refractive index that is lower than the first refractive index such that the core and the first cladding comprise an optical waveguide that concentrates a majority of light transmitted along the fiber in the core. The first measurement instrument measures a transmission loss of the light transmitted along the fiber and determines the strain exerted on the fiber based at least in part on the measured transmission loss.

In accordance with another aspect, the first and second channels are formed in the first cladding, and the first cladding is encapsulated in an encapsulation such the EC liquid is encapsulated by an inner surface of the encapsulation and the channels formed in the first cladding.

In accordance with another aspect, the diameter of the fiber ranges from between 200 micrometers (µm) and 2 millimeters (mm).

In accordance with another aspect, the stretchable polymer fiber has a stretchability that is greater than 10%.

In accordance with another aspect, the stretchable polymer fiber has a stretchability that is greater than 150%.

In accordance with another aspect, the stretchable polymer fiber has a stretchability that is greater than 600%.

In accordance with another aspect, a strain sensor is provided that comprises a stretchable optical waveguide comprising a stretchable polymer fiber and at least a first measurement instrument. The stretchable polymer fiber comprises a core and at least a first cladding. The core comprises a stretchable polymer having a first refractive index and having a stretchability that is greater than or equal to 150%. The first cladding surrounds the core and comprises a stretchable polymer having a second refractive index that is lower than the first refractive index such that the core and the first cladding comprise an optical waveguide that concentrates a majority of light transmitted along the fiber in the core. The stretchable polymer of the first cladding has a stretchability that is greater than or equal to 150%. Strain exerted on the fiber changes an optical transmission loss of the light transmitted along the fiber. The first measurement instrument is optically coupled to the stretchable optical waveguide. The first measurement instrument measures the change in optical transmission loss and determines the strain exerted on the fiber based at least in part on the measured change in optical transmission loss.

In accordance with another aspect, the strain sensor further comprises at least a first electrode comprising an EC liquid disposed in at least a first channel formed in the fiber and extending in a direction generally parallel to a longitudinal axis of the fiber. The first measurement instrument is electrically coupled to the first electrode. Strain exerted on the fiber changes an electrical resistance of the first electrode. The first measurement instrument measures the change in electrical resistance and determines the strain exerted on the fiber based at least in part on the measured change in electrical resistance.

In accordance with another aspect, when the fiber is stretched, the length of the EC liquid increases and a cross-sectional area of the EC liquid decreases, thereby increasing the electrical resistance of the electrode. When the stretching force is released, the length of the EC liquid decreases and the cross-sectional area of the EC liquid increases, thereby decreasing the electrical resistance of the electrode.

In accordance with another aspect, said at least a first electrode further comprises at least a second electrode comprising the EC liquid disposed in a second channel formed in the fiber. When the fiber is stretched, the length of the EC liquid disposed in the second channel increases and the cross-sectional area of the EC liquid disposed in the second channel decreases, thereby increasing the electrical resistance of the second electrode. When the stretching force is released, the length of the EC liquid disposed in the second channel decreases and the cross-sectional area of the EC liquid disposed in the second channel increases, thereby decreasing the electrical resistance of the second electrode. The first measurement instrument measures the change in electrical resistance and determines the strain exerted on the fiber based at least in part on the measured change in electrical resistance of the second electrode.

It should be noted that the illustrative embodiments have been described with reference to a few embodiments for the purpose of demonstrating the principles and concepts of the invention. Persons of skill in the art will understand how the principles and concepts of the invention can be applied to other embodiments not explicitly described herein. For example, while particular fiber embodiments and strain-sensor fiber configurations are described herein and shown in the figures, a variety of other embodiments and configurations may be used. Also, the applications for which the fibers and strain-sensor configurations are used are not limited to the example applications described herein. As will be understood by those skilled in the art in view of the description provided herein, many modifications may be made to the embodiments described herein while still achieving the goals of the invention, and all such modifications are within the scope of the present disclosure.

What is claimed is:

1. A strain sensor comprising:
a stretchable polymer fiber;
at least a first electrode disposed in or on the fiber and extending in a direction generally parallel to a longitudinal axis of the fiber, wherein strain exerted on the fiber changes an electrical resistance of said at least a first electrode; and
at least a first measurement instrument electrically coupled to said at least a first electrode, said at least a first measurement instrument measuring the change in electrical resistance and determining the strain exerted on the fiber based at least in part on the measured change in resistance.

2. The strain sensor of claim 1, wherein the stretchable polymer fiber is made of a thermal plastic polymer selected from the group comprising polyethylene (PE), polyvinylidene fluoride (PVDF), polycarbonate (PC), poly(methyl methacrylate) (PMMA), and thermal plastic elastomer (TPE).

3. The strain sensor of claim 1, wherein said at least a first electrode comprises regions in the stretchable polymer fiber that are doped with electrically-conductive (EC) particles that form EC paths in the fiber when the fiber is in an unstretched state.

4. The strain sensor of claim 3, wherein the EC particles are carbon black (CB) particles.

5. The strain sensor of claim 3, wherein when the doped polymer fiber is stretched, one or more of the EC paths disconnect, thereby increasing the electrical resistance, and wherein when the stretching force exerted on the polymer fiber is released, the EC paths reconnect, thereby decreasing the electrical resistance.

6. The strain sensor of claim 1, wherein said at least a first electrode comprises an electrically-conductive (EC) liquid disposed in at least a first channel formed in the fiber.

7. The strain sensor of claim 1, wherein when the fiber is stretched, a length of the EC liquid increases and a cross-sectional area of the EC liquid decreases, thereby increasing the electrical resistance of the electrode, and wherein when the stretching force is released, the length of the EC liquid decreases and the cross-sectional area of the EC liquid increases, thereby decreasing the electrical resistance of the electrode.

8. The strain sensor of claim 7, wherein said at least a first electrode further comprises at least a second electrode comprising the EC liquid disposed in a second channel formed in the fiber, wherein when the fiber is stretched, a length of the EC liquid disposed in the second channel increases and a cross-sectional area of the EC liquid disposed in the second channel decreases, thereby increasing the electrical resistance of the second electrode, and wherein when the stretching force is released, the length of the EC liquid disposed in the second channel decreases and the cross-sectional area of the EC liquid disposed in the second channel increases, thereby decreasing the electrical resistance of the second electrode, said at least a first measurement instrument measuring the change in electrical resistance and determining the strain exerted on the fiber based at least in part on the measured change in electrical resistance.

9. The strain sensor of claim 8, wherein the fiber comprises core and at least a first cladding, the core comprising a stretchable polymer having a first refractive index, the first cladding comprising a stretchable polymer having a second refractive index that is lower than the first refractive index such that the core and said at least a first cladding comprise an optical waveguide that concentrates a majority of light transmitted along the fiber in the core, said at least a first measurement instrument measuring a transmission loss of the light transmitted along the fiber and determining the strain exerted on the fiber based at least in part on the measured transmission loss.

10. The strain sensor of claim 9, wherein the first and second channels are formed in the first cladding, and wherein the first cladding is encapsulated in an encapsulation such the EC liquid is encapsulated by an inner surface of the encapsulation and the channels formed in the first cladding.

11. The strain sensor of claim 1, wherein a diameter of the fiber ranges from between 200 micrometers (µm) and 2 millimeters (mm).

12. The strain sensor of claim 1, wherein the stretchable polymer fiber has a stretchability that is greater than 10%.

13. The strain sensor of claim 1, wherein the stretchable polymer fiber has a stretchability that is greater than 150%.

14. The strain sensor of claim 11, wherein the stretchable polymer fiber has a stretchability that is greater than 600%.

15. A strain sensor comprising:
a stretchable optical waveguide comprising:
a stretchable polymer fiber comprising a core and at least a first cladding, the core comprising a stretchable polymer having a first refractive index, the stretchable polymer having a stretchability that is greater than or equal to 150%, the first cladding surrounding the core and comprising a stretchable polymer having a second refractive index that is lower than the first refractive index such that the core and said at least a first cladding comprise an optical waveguide that concentrates a majority of light transmitted along the fiber in the core, the stretchable polymer of the first cladding having a stretchability that is greater than or equal to 150%, wherein strain exerted on the fiber changes an optical transmission loss of the light transmitted along the fiber; and
at least a first measurement instrument optically coupled to the stretchable optical waveguide, said at least a first measurement instrument measuring the change in optical transmission loss and determining the strain exerted on the fiber based at least in part on the measured change in optical transmission loss.

16. The strain sensor of claim 15, further comprising:
at least a first electrode comprising an electrically-conductive (EC) liquid disposed in at least a first channel formed in the fiber and extending in a direction generally parallel to a longitudinal axis of the fiber, wherein said at least a first measurement instrument is electrically coupled to said at least a first electrode, and wherein strain exerted on the fiber changes an electrical resistance of said at least a first electrode, said at least a first measurement instrument measuring the change in electrical resistance and determining the strain exerted on the fiber based at least in part on the measured change in electrical resistance.

17. The strain sensor of claim 16, wherein when the fiber is stretched, a length of the EC liquid increases and a cross-sectional area of the EC liquid decreases, thereby increasing the electrical resistance of the electrode, and wherein when the stretching force is released, the length of the EC liquid decreases and the cross-sectional area of the EC liquid increases, thereby decreasing the electrical resistance of the electrode.

18. The strain sensor of claim 17, wherein said at least a first electrode further comprises at least a second electrode comprising the EC liquid disposed in a second channel formed in the fiber, wherein when the fiber is stretched, a length of the EC liquid disposed in the second channel increases and a cross-sectional area of the EC liquid disposed in the second channel decreases, thereby increasing the electrical resistance of the second electrode, and wherein when the stretching force is released, the length of the EC liquid disposed in the second channel decreases and the cross-sectional area of the EC liquid disposed in the second channel increases, thereby decreasing the electrical resistance of the second electrode, said at least a first measurement instrument measuring the change in electrical resistance and determining the strain exerted on the fiber based at least in part on the measured change in electrical resistance of the second electrode.

19. The strain sensor of claim 15, wherein a diameter of the fiber ranges from between 200 micrometers (µm) and 2 millimeters (mm).

20. The strain sensor of claim 15, wherein the stretchable polymer fiber has a stretchability that is greater than 150%.

21. The strain sensor of claim 15, wherein the stretchable polymer fiber has a stretchability that is greater than 600%.
